(19) United States
(12) Patent Application Publication
(10) Pub. No.: US 2007/0262944 A1
(43) Pub. Date: Nov. 15, 2007

(54) APPARATUS AND METHOD FOR DRIVING A DISPLAY PANEL

(75) Inventor: Pen-Hsin CHEN, Tainan County (TW)

Correspondence Address: LOWE HAUPTMAN HAM & BERNER, LLP, 1700 DIAGONAL ROAD, SUITE 300, ALEXANDRIA, VA, 22314, US

(73) Assignee: HIMAX TECHNOLOGIES LIMITED, Tainan County (TW)

(21) Appl. No.: 11/745,824

(22) Filed: May 8, 2007

Related U.S. Application Data
(60) Provisional application No. 60/798,744, filed on May 9, 2006.

(51) Int. Cl. G09G 3/36

(52) U.S. Cl. 345/98

(57) ABSTRACT

An apparatus for driving a display panel is provided. The apparatus is adapted to a LCD panel. The apparatus at least has a processor, a first and second timing controllers and a first and second group of source drivers. Real pixels are input from an input port of the processor. The real pixels are converted to impulsive pixels with a pre-determined frame rate. The impulsive pixels are divided into two groups of pixels by the processor. The two groups of pixels are simultaneously sent to the source drivers though two timing controllers, respectively. Finally, the source drivers generate driving voltages for the display panel.

### RELATED APPLICATIONS

This application claims priority to U.S. Provisional Application Ser. No. 60/798,744, filed May 9, 2006, which is herein incorporated by reference.

### BACKGROUND

1. Field of Invention

The present invention relates to an apparatus and method for driving a display panel. More particularly, the present invention relates to an apparatus and method for driving a LCD panel operating at a high frame rate.

2. Description of Related Art

In recent years, optical electronics related technologies has been continually experiencing breakthroughs. The arrival of the digital age has propelled the display market to significant growth. Liquid crystal display (LCD) features advantages such as high resolution, small size, lightweight, low driving voltage, and low power dissipation. Therefore they are widely applied to consumer telecommunications and electronics products such as personal digital assistants (PDA), mobile phones, video cameras, laptop computers, desktop monitors displays, in-car displays, and television projectors. They are also becoming the mainstream of displays replacing cathode ray tubes.

Liquid Crystal Display is a display device using the characteristics of liquid crystals to achieve the displaying effect. A source driver is for receiving digital frame signals from a timing controller (TCON) and converting them into analog voltage signals to transfer frame signals to the display. Refer to FIG. 1, illustrating a conventional driving apparatus for a display. Digital frame signals from an image processor (not shown) or a scaler (not shown) goes into the TCON 20, TCON 20 rearranges the digital frame signal carrying pixels, and sends them to source driver group 30. The source driver group 30 then, according to the received pixels, produces corresponding driving voltages to drive the liquid crystal panel (not shown). For example, suppose the display panel has 240 scan lines, each source driver may be connected to 30 scan lines, which means the group of source drivers 30 includes 8 source drivers, In order to prevent flickers and traces from happening, traditional display panels display frames at a refresh rate of 50˜60 Hz. Since the response time of the display panel is decreasing, display panels which refresh at 120 Hz are starting to appear. The source drivers for such display panels must be able to process frame signals at 120 Hz. However, raising the operating frequency of the driving apparatus from 50˜60 Hz up to 120 Hz causes many problems to arise, such as electromagnetic interference, high power dissipation etc. . . .

### SUMMARY

One embodiment of the present invention is an apparatus for driving a display panel. The apparatus includes a processor outputting data of a first and second group of pixels on a scan line. The apparatus also includes a first and second timing controllers operating in parallel, which rearrange a sequence of the first and second group of pixels, and output a first and second control signal, and the rearranged first and second group of pixels, respectively. Moreover, the apparatus includes a first and second group of source drivers respectively receiving the rearranged first and second group of pixels, and the first and second control signal, and accordingly generating driving voltages for the display panel.

The present invention uses the existing devices with an operating frequency of 50-60 Hz to design a driving circuit for display televisions which may process digital frame signals at 120 Hz and effectively improve the present problem of the lack of abilities in display television dynamic image processing.

Additionally, display televisions with the driving circuit capable of processing digital frame signals at 100-120 Hz may also use 120 Hz video signals from plasma televisions to increase the compatibility of display televisions and plasma televisions.

Therefore, the present invention provides a driving apparatus for a display panel, adapted to the driving circuits of the display panel and may use conventional single frequency channel to process digital frame signals with double or higher frequencies. The driving apparatus for the display panel at least comprises a processor, at least 2 TCON and at least one source driver group. When a single frequency digital frame signal is sent to the input of the processor, it becomes an impulsive frame signal with double frequency after being processed by the processor. The processor divides the impulsive frame signal with double frequency into two parts and simultaneously inputted from the two TCON to sources drivers respectively driving the display panel. When a digital frame signal with double frequency is sent to the input of the processor, the processor only divides the frame signal with double frequency into two parts and simultaneously inputted from the two TCON to source drivers respectively driving the display panel.

Similarly, a digital frame signal may also become impulsive frame signals with triple, quadruple, or higher multi-frequency after being processed by the processor. Correspondingly, if it is an impulsive frame signal with triple frequency, then it requires 3 TCON dividing the impulsive frame signal into 3 parts.

The ways for the processor to divide digital frame signals with multi-frequency may be to divide by the number of line data, for example, digital frame data with double frequency may be divided into a front side and a back side or may be divided into odd and even numbers of line data. Each part of the digital frame signal will be simultaneously sent to a TCON. When dividing by odd and even numbers of line dada, the processor may selectively include a communication mechanism to communicate between two single frequency is timing controllers thus leads to smoother frame presentation.

Each part of the digital frame signal may be transmitted from the TCON to the source driver in three ways. The first way is to again divide each part of the digital frame data, for example, when a digital frame data with double frequency is under processing, each part of the digital frame signal may be divided into a front side and a back side or into odd and even numbers of line data. All parts are simultaneously sent to the two source driver groups, wherein the TCON and the source driving groups are connected serially or point-to-point. The third way is to connect each TCON with one source driver group, single frequency TCON sorts each part of the digital frame signal by pairs of adjacent odd and even line data, such as line 1 and 2, line 3 and 4 . . . and send each part of the digital frame data to the source driver group.

Additionally, the processor and the single frequency TCON may be integrated onto a single chip, take the double frequency for example, one processor and one TCON circuit or one processor and two TCON circuits may be integrated onto a single chip.

When using the driving apparatus for the display panel provided by the present invention, there is no need for further development of multi-frequency TCON and source drivers. The existing single frequency TCON and source drivers may be used to satisfy the requirements for processing digital frame data with multi-frequency. Furthermore, not only is the digital frame data with double frequency may be processed, when faced with processing needs for digital frame data with multi-frequency, the requirements for processing digital frame data with multi-frequency may be complied based on the same expansion method.

### BRIEF DESCRIPTION OF THE DRAWINGS

The embodiments of the invention can be more fully understood by reading the following detailed description of the preferred embodiment, with reference made to the accompanying drawings as follows:

FIG. 1 illustrates the conventional signal transmission;

FIG. 2 is a driving apparatus for display panel according to the first preferred embodiment of this invention.

FIG. 3 is a driving apparatus for display panel according to the second preferred embodiment of this invention.

FIG. 4A and FIG. 4B illustrate a driving apparatus for display panel with the processor and TCON circuit integrated together according to the first preferred embodiment of this invention.

FIG. 5A and FIG. 5B illustrate a driving apparatus for display panel with the processor and TCON circuit integrated together according to the second preferred embodiment of this invention.

FIG. 6 is a flow diagram of the method for driving a display panel.

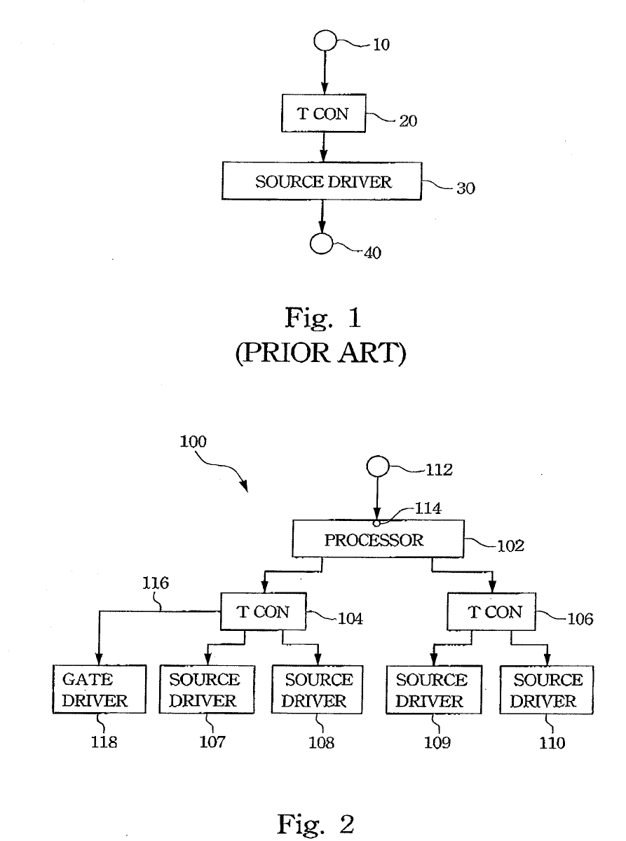

### DESCRIPTION OF THE PREFERRED EMBODIMENTS

Reference will now be made in detail to the present embodiments of the invention, examples of which are illustrated in the accompanying drawings. Wherever possible, the same reference numbers are used in the drawings and the description to refer to the same or like parts.

Referring to FIG. 2, a driving apparatus for display panel according to the first embodiment of this invention. The driving apparatus for display panel 100 comprises a processor 102, a first and second TCON 104, 106, a first group of source drivers 107, 108, and a second group of source drivers 109, 110. Each group of source drivers 107, 108, 109, 110 includes a plurality of source drivers. These source drivers are serially or point-to-point connected with the TCON 104 or 106.

Real pixels 112 from either an image processor or a scaler are inputted to the input 114 of processor 102. When the real pixels 112 carrying image frame frequency (ex. 60 Hz) is lower than a pre-determined frame frequency (ex. 120 Hz), causing the processor 102 to be unable to receive sufficient number of frames, thus the processor 102 uses interpolation to insert new pixels onto the real pixels 112 carrying image frames in order to acquire enough frames of impulsive pixels (ex. 120 frames). When the real pixels 112 carrying image frame rate is higher than a pre-determined frame rate, processor 102 uses a sampling method to filter out parts of the real pixels 112 carrying image frames to acquire the impulsive pixels. When the real pixels 112 carrying image frame rate is equal to a pre-determined frame rate, since the processor 102 already received enough frames, therefore the processor 102 will not produce any new pixels, but directly use the original pixels as the impulsive pixels.

The processor 102 then divides each of the impulsive pixels into a first group of pixels and a second group of pixels, and sends them to each of the TCON 104 and 106. Take the picture frequency at 120 Hz as an example, although the processor 102 is required to transmit 120 impulsive pixels in 1 second, but since the pixels of each image frame is divided into two groups and transmitted in parallel, the TCON 104 or 106 only receive pixels from 60 image frames in 1 second. Thus, the operation frequency of the TCON 104 and 106 may be the same as the operation frequency of the traditional image frame reception when the frame rate is 60 Hz.

One of the timing controllers, for example, TCON 104 sends a gate driving signal 1163 to the gate driver 118. In addition, the TCON 104 takes the received first group of pixels, rearrange them into two rearranged groups of pixels, and send them in parallel to the groups source drivers 107 and 108. Similarly, the TCON 106 takes the received second group of pixels, rearrange them into two groups, and send them in parallel to the group source drivers 109 and 110. Moreover, upon receiving the first and second groups of pixels, TCON 104 and TCON 106 output a first and second control signals, respectively. Finally, the source drivers in the groups of source drivers 107, 108, 109 and 110 produce corresponding driving voltages for the display panel according to the received groups of pixels and the control signals.

The grouping of the source drivers will vary due to the different ways of dividing pixels by the processor 102 and TCON 104, 106. The following takes a display panel with 240 scan lines, the 240 scan lines are sequentially connected to 1 to 8 source drivers (each source driver connects 30 scan lines) as an example to explain four difference ways of division.

First, processor 102 may divide pixels of the first and second group each into a first half and a second half, meaning the processor 102 divides the pixels of the first group and second group into pixels on the scan lines connected to 1˜4 source drivers and pixels on the scan lines connected to 5˜8 source drivers and send each of them to TCON 104 and 106; TCON 104 and 106 then may take the received pixels and in similar fashion divide them into two groups of first and second halves, meaning the TCON 104 may take the received pixels and further rearrange them into pixel groups on the scan lines connected to the 1^{st}, 2^{nd} and 3^{rd}, 4^{th} source drivers, the TCON 106 may take the received pixels and further rearrange them into pixel groups on the scan lines connected to the 5^{th}, 6^{th} and 7^{th}, 8^{th} source drivers. Therefore, groups of source drivers 107,108 109 and 110 each comprises of 1^{st} and 2^{nd}, 3^{rd} and 4^{th}, 5^{th} and 6^{th}, 7^{th} and 8^{th} source drivers.

Second, processor 102 may take the pixels of the first and second group, divide them into the first and second halves and send them each to TCON 104 and 106; TCON 104 and 106 then may take the received pixels and rearrange them into two groups by respective odd and even number of source drivers, meaning the TCON 104 may take the received pixels and further rearrange them into respective pixels on the scan lines connected to the 1^{st}, 3^{rd} and 2^{nd}, 4^{th} source drivers, the TCON 106 may take the received pixels and further rearrange them into pixel groups on the scan lines connected to the 5^{th}, 7^{th} and 6^{th}, 8^{th} source drivers. Therefore, source driver groups 107,108 109 and 110 each comprises of 1^{st} and 3^{rd}, 2^{nd} and 4^{th}, 5^{th} and 7^{th}, 6^{th} and 8^{th} source drivers.

Third, processor 102 may take the pixels of the first and second group and divide them into two groups by respective odd and even number of source drivers, meaning the processor 102 may take pixels and divide them into pixels on the scan lines connected to the 1^{st}, 3^{rd}, 5^{th}, 7^{th} source drivers, and pixels on the scan lines connected to the 2^{nd}, 4^{th}, 6^{th}, 8^{th} source drivers, and then send them each to TCON 104 and 106. TCON 104 and 106 then may take the received pixels and rearrange them into two groups by the first half and the second half, meaning the TCON 104 may take the received pixels and further rearrange them into pixels on the scan lines connected to the 1^{st}, 3^{rd} and 5^{th}, 7^{th} source drivers, the TCON 106 may take the received pixels and further rearrange them into pixels on the scan lines connected to the 2^{nd}, 4^{th} and 6^{th}, 8^{th} source drivers. Therefore, source driver groups 107,108 109 and 110 each comprises of 1^{st} and 3^{rd}, 5^{th} and 7^{th}, 2^{nd} and 4^{th}, 6^{th} and 8^{th} source drivers.

Fourth, processor 102 may take the pixels of the first and second group and divide them into two groups by respective odd and even number of source drivers and send them each to TCON 104 and 106. TCON 104 and 106 then may take the received pixels and divide them into two groups by respective odd and even number of source drivers, meaning the TCON 104 may take the received pixels on the scan lines connected to the 1^{st}, 3^{rd}, 5^{th}, 7^{th} source drivers and further divide them into pixels on the scan lines connected to the 1^{st}, 5^{th} and 3^{rd}, 7^{th} source drivers, the TCON 106 may take the received pixels on the scan lines connected to the 2^{nd}, 4^{th}, 6^{th}, 8^{th} source drivers and further divide them into pixels on the scan lines connected to the 2^{nd}, 6^{th} and 4^{th}, 8^{th} source drivers. Therefore, groups of source drivers 107, 108 109 and 110 each comprises of 1^{st} and 5^{th}, 3^{rd} and 7^{th}, 2^{nd} and 6^{th}, 4^{th} and 8^{th} source drivers.

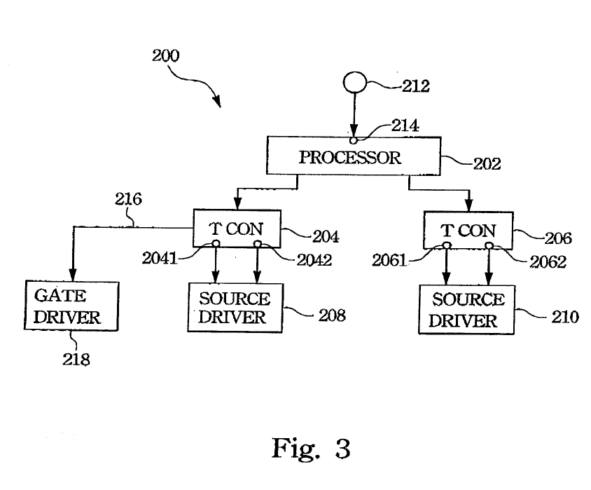

Referring to FIG. 3, a driving apparatus for display panel according to the second embodiment of this invention. The driving apparatus for display panel 200 comprises a processor 202, a first and second timing controllers TCON 204, 206, and a first and second group of source drivers 208, 210. Each group of source drivers 208 or 210 includes a plurality of source drivers (not shown). These source drivers are serially or point-to-point connected with the TCON 204 or 206.

Real pixels 212 from either an image processor or a scaler are inputted to the input 214 of processor 202. When the real pixels 212 carrying picture frame frequency (ex. 60 Hz) is lower than a pre-determined picture frequency (ex. 120 Hz), causing the processor 202 to be unable to receive sufficient number of pictures, thus the processor 202 uses interpolation to insert new pixels onto the real pixels 212 carrying image frames in order to acquire enough frames of impulsive pixels (ex. 120 frames). When the real pixels 212 carrying image frame rate is higher than a pre-determined frame rate, processor 202 uses a sampling method to filter out parts of the real pixels 212 carrying image frames to acquire the impulsive pixels. When the real pixels 212 carrying image frame rate is equal to a pre-determined frame rate, since the processor 202 already received enough frames, therefore the processor 202 will not produce any new pixels, but directly use the original pixels as the impulsive pixels.

The processor 202 then divides each of the impulsive pixels into a first group of pixels and a second group of pixels, and sends them to each of the TCON 204 and 206. Take the picture frequency at 120 Hz as an example, although the processor 202 is required to transmit 120 impulsive pixels in 1 second, but since the pixels of each image frame is divided into two groups and transmitted in parallel, the TCON 204 or 206 only receive pixels from 60 image frames in 1 second. Thus, the operation frequency of the TCON 204 and 206 may be the same as the operation frequency of the traditional image frame reception when the frame rate is 60 Hz.

One of the timing controllers, for example, TCON 204 sends a gate driving signal 216 to the gate driver 218. In addition, the TCON 204 takes the received first group of pixels, rearrange them into two rearranged groups of pixels, and send them out from outputs 2041 and 2042 in parallel to the group of source drivers 208. Similarly, the TCON 206 takes the received second group of pixels, rearrange them into two rearranged groups of pixels, and send them out from outputs 2061 and 2062 in parallel to the group of source drivers 210. Moreover, upon receiving the first and second groups of pixels, TCON 104 and TCON 106 output a first and second control signals, respectively. Finally, the source drivers in the groups of source drivers 208, and 210 produce corresponding driving voltages for the display panel according to the received groups of pixels and the control signals.

The grouping of the source drivers will vary due to the connection between input port of the source driver groups 208, 210 for receiving pixels and the output port of the TCON 204, 206. The grouping will also vary due to the different ways of dividing pixels by the processor 202 and TCON 204, 206. The following is takes a display panel with 240 scan lines, the 240 scan lines are sequentially connected to 1 to 8 source drivers (each source driver connects 30 scan lines) as an example to explain four difference ways of division.

First, processor 202 may divide pixels of the each picture into a first half and a second half, meaning the processor 202 divides the pixels of each image frame into pixels on the scan lines connected to 1-4 source drivers and pixels on the scan lines connected to 5-8 source drivers and send each of them to TCON 104 and 106; TCON 204 and 206 then may take the received pixels and rearrange them into two groups by respective odd and even number of scan lines, meaning the TCON 204 may take the received pixels on the scan lines (lines 1˜120) connected to the 1^{st}˜4^{th} source drivers and further rearrange them into pixels on the 1^{st}, 3^{rd}, 5^{th}, . . . , 119^{th} scan lines and pixels on the 2^{nd}, 4^{th}, 6^{th}, . . . , 120^{th} scan lines, then output them each from the output ports 2041 and 2042, the TCON 206 may take the received pixels on the scan lines (lines 121˜240) connected to the 5^{th}˜8^{th} source drivers and further divide them into pixels on the 121^{st}, 123^{rd}, 125^{th}, . . . , 239^{th} scan lines and pixels on the 120^{th}, 122^{nd}, 124^{th}, . . . , 240^{th} scan lines, then output them each from the output ports 2061 and 2062. Therefore, groups of source drivers 208 and 210 each comprise of the 1^{st}˜4^{th}, and 5^{th}˜8^{th} source drivers. In the group of source drivers 208, all the receiving ports of the pixels on respective odd number of source driver scan lines are connected to output port 2041, and all the receiving ports of the pixels on even number of source driver scan lines are connected to output port 2042. In the group of source driver 210, all the receiving ports of the pixels on respective odd number of source driver scan lines are connected to output port 2061, and all the receiving ports of the pixels on even number of source driver scan lines are connected to output port 2062.

Second, processor 202 may take the pixels of each image frame, divide them into the first and second halves and send them each to TCON 204 and 206; TCON 204 and 206 then may take the received pixels and rearrange them into two groups by the first half and the second half, meaning the TCON 204 may take the received pixels on the scan lines (lines 1˜120) connected to the 1^{st}˜4^{th} source drivers and further rearrange them into pixels on the 1^{st}˜60^{th} scan lines and pixels on the 61^{st}˜120^{th} scan lines, then output them each from the output ports 2041 and 2042, the TCON 206 may take the received pixels on the scan lines (lines 121˜240) connected to the 5^{th}˜8^{th} source drivers and further rearrange them into pixels on the 121^{st}˜180^{th} scan lines and pixels on the 181^{th}˜240^{th} scan lines, then output them each from the output ports 2061 and 2062. Therefore, source driver groups 208 and 210 each comprise of the 1^{st}˜4^{th}, and 5^{th}˜8^{th} source drivers. In the source driver group 208, all the receiving ports of the pixels on the 1^{st}, 2^{nd} source drivers are connected to output port 2041, and all the receiving ports of the pixels on the 3^{rd}, 4^{th} source drivers are connected to output port 2042. In the source driver group 210, all the receiving ports of the pixels on the 5^{th}, 6^{th} source drivers are connected to output port 2061, and all the receiving ports of the pixels on the 7^{th}, 8^{th} source drivers are connected to output port 2062.

Third, processor 202 may take the pixels of each picture and divide them into two groups by respective odd and even number of source drivers, meaning the processor 202 may take pixels of each image frame and divide them into pixels on the scan lines connected to the 1^{st}, 3^{rd}, 5^{th}, 7^{th} source drivers, and pixels on the scan lines connected to the 2^{nd}, 4^{th}, 6^{th}, 8^{th} source drivers, and then send them each to TCON 204 and 206. TCON 204 and 206 then may take the received pixels and rearrange them into two groups by respective odd and even number of scan lines, meaning the TCON 204 may take the received pixels on the scan lines (lines 1˜30, 61˜90, 121˜150, 181˜210) connected to the 1^{st}, 3^{rd} and 5^{th}, 7^{th} source drivers and further rearrange them by pixels of respective odd and even number of scan lines, then output them each from the output ports 2041 and 2042, the TCON 206 may take the received pixels on the scan lines (lines 31˜60, 91˜120, 151˜180, 211˜240) connected to the 2^{nd}, 4^{th} and 6^{th}, 8^{th} source drivers and further rearrange them by pixels of respective odd and even number of scan lines, then output them each from the output ports 2061 and 2062. Therefore, the groups of source drivers 208 and 210 each comprise of 1^{st}, 3^{rd}, 5^{th}, 7^{th} and 2^{nd}, 4^{th}, 6^{th}, 8^{th} source drivers. In the group of source drivers 208, all the receiving ports of the pixels on odd number of source driver scan lines are connected to output port 2041, and all the receiving ports of the pixels on even number of source driver scan lines are connected to output port 2042. In the group of source drivers 210, all the receiving ports of the pixels on odd number of source driver scan lines are connected to output port 2061, and all the receiving ports of the pixels on even number of source driver scan lines are connected to output port 2062.

Fourth, the processor 202 may take the pixels of the first and second group and divide them into two groups by respective odd and even number of source drivers and send them each to TCON 204 and 206. TCON 204 and 206 then may take the received pixels and rearrange them into two groups by the first half and the second half, meaning the TCON 104 may take the received pixels on the scan lines connected to the 1^{st}, 3^{rd}, 5^{th}, 7^{th} source drivers and further rearrange them into pixels on the scan lines connected to the 1^{st}, 3^{rd} and 5^{th}, 7^{th} source drivers, then output them each from the output ports 2041 and 2042, the TCON 206 may take the received pixels on the scan lines connected to the 2^{nd}, 4^{th}, 6^{th}, 8^{th} source drivers and further divide them into pixels on the scan lines connected to the 2^{nd}, 4^{th} and 6^{th}, 8^{th} source drivers. Therefore, the groups of source drivers 208 and 210 each comprise of 1^{st}, 3^{rd}, 5^{th}, 7^{th} and 2^{nd}, 4^{th}, 6^{th}, 8^{th} source drivers. In the source driver group 208, all the receiving ports of the pixels on the 1^{st}, 3^{rd} source drivers are connected to output port 2041, and all the receiving ports of the pixels on the 5^{th}, 7^{th} source drivers are connected to output port 2042. In the source driver group 210, all the receiving ports of the pixels on the 2^{nd}, 4^{th} source drivers are connected to output port 2061, and all the receiving ports of the pixels on the 6^{th}, 8^{th} source drivers are connected to output port 2062.

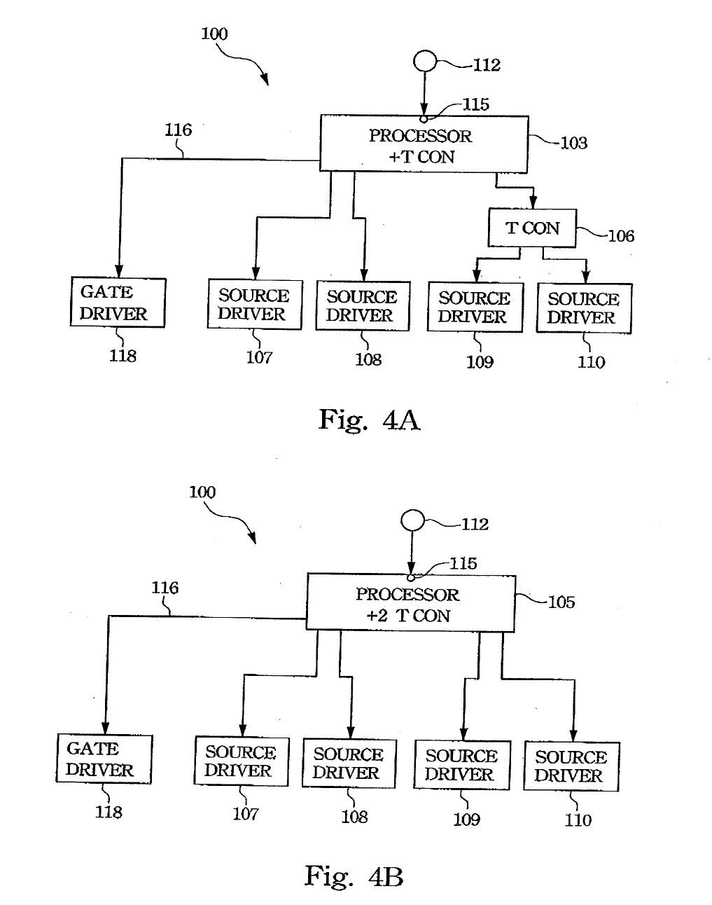

In the above embodiment, the processor and TCON may be integrated onto a single chip, take double frequency for example, one processor and one TCON or one processor and two TCON may both be integrated onto a single chip in order to cost down. FIG. 4A and FIG. 4B each illustrate a driving apparatus for display panel with the processor and TCON circuit integrated together according to the first preferred embodiment of this invention. FIG. 4A illustrates the driving apparatus for display panel after integrating the processor 102 and the TCON 104 in FIG. 2 into a single chip 103. FIG. 4B illustrates the driving apparatus for display panel after integrating the processor 102 and the TCON 104, 106 in FIG. 2 into a single chip 105.

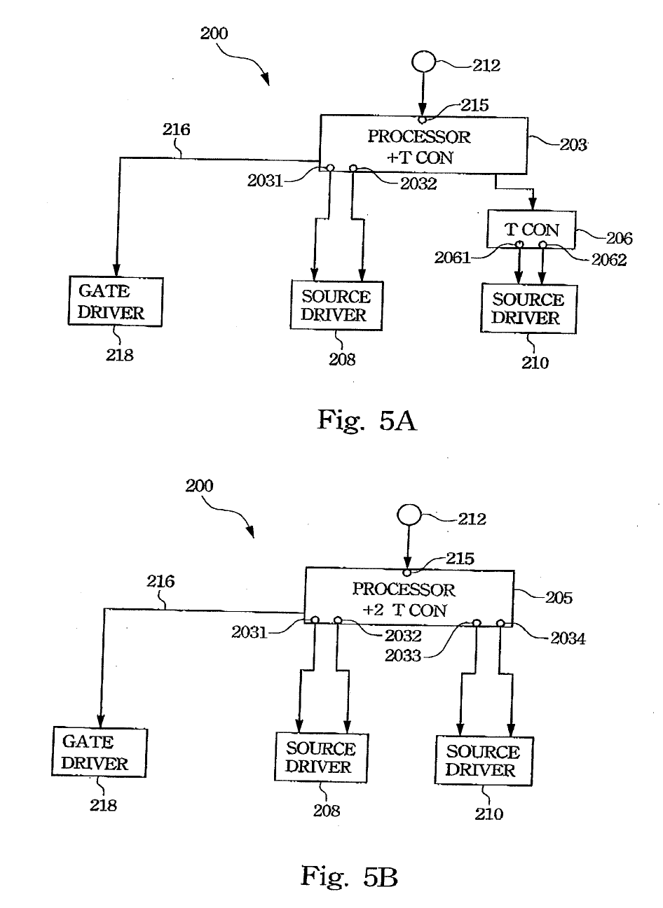

FIG. 5A and FIG. 5B each illustrate a driving apparatus for display panel with the processor and TCON circuit integrated together according to the first preferred embodiment of this invention, FIG. 5A illustrates the driving apparatus for display panel after integrating the processor 202 and the TCON 204 in FIG. 3 into a single chip 203. Chip 203 may take the received pixels on the scan lines connected to the 1^{st}, 3^{rd}, 5^{th}, 7^{th} source drivers and further divide them by pixels on the scan lines connected to the 1^{st}, 3^{rd} and 5^{th}, 7^{th} source drivers, then output them each from the output ports 2031 and 2032, TCON 206 may take the received pixels on the scan lines connected to the 2^{nd}, 4^{th}, 6^{th}, 8^{th} source drivers and further divide them by pixels on the scan lines connected to the 2^{nd}, 4^{th} and 6^{th}, 8^{th} source drivers, then output them each from the output ports 2061 and 2062. Output ports 2031 and 2032 have the same functions as output ports 2041 and 2042 of FIG. 3.

FIG. 5B illustrates the driving apparatus for display panel after integrating the processor 202 and the TCON 204, 206 in FIG. 3 into a single chip 205. Chip 205 may take the received pixels on the scan lines connected to the 1^{st}, 3^{rd} and 5^{th}, 7^{th} source drivers and further divide them by pixels on the scan lines connected to the 1^{st}, 3^{rd} and 5^{th}, 7^{th} source drivers, then output them each from the output ports 2031 and 2032, chip 205 may also take the received pixels on the scan lines connected to the 2^{nd}, 4^{th}, 6^{th}, 8^{th} source drivers and further divide them by pixels on the scan lines connected to the 2^{nd}, 4^{th} and 6^{th}, 8^{th} source drivers, then output them each from the output ports 2033 and 2034. Output ports 2031, 2032, 2033, and 2034 have the same functions as output ports 2041, 2042, 2061, and 2062 of FIG. 3.

The apparatus for driving a display panel may be used in a liquid crystal display device, which includes a display panel and the apparatus described above for driving the display panel.

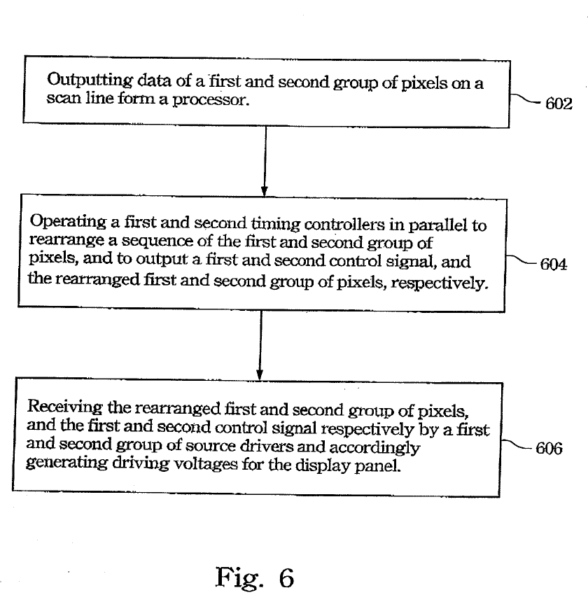

Further more, a third embodiment of the present invention includes a method for driving a display panel. Please refer to FIG. 6, illustrating a flow diagram of the method. The method includes the steps of an outputting step 602, outputting data of a first and second group of pixels on a scan line form a processor. Next, a timing controller operation step 604 to operate a first and second timing controllers in parallel to rearrange a sequence of the first and second group of pixels, and to output a first and second control signal, and the rearranged first and second group of pixels, respectively. Lastly, a receiving step 606, receiving the rearranged first and second group of pixels, and the first and second control signal respectively by a first and second group of source drivers and accordingly generating driving voltages for the display panel.

Before outputting the data of the first and second group of pixels, additional steps are taken. First, impulsive pixels are created from real pixels, Second, the impulsive pixels and the real pixels are composed to form pixels in order to compensate for a lack of pixels or to filter out extra pixels. Finally, dividing the pixels into the first and the second group of pixels onto the scan line. In addition, each group of source drivers has at least two source drivers therein.

The ways pixels are received, divided, and rearranged in the method of the present embodiment is in accordance with the above mentioned ways of division in the first and second embodiments.

When using the apparatus and method for driving a display panel provided by the present embodiments, the capability of driving display panels with high frame rate may be acquired by using the existing TCON and source drivers. The present invention not only eliminates the need for the development of high frame rate TCON and source drivers thus saves time; it also eliminates the problem of electromagnetic interference in high frequency devices. Furthermore, the number of scan lines being 240 and the number of source drivers being 8 in the embodiments are merely for explanation purposes, they are not meant to be limiting to the scope of the present invention. The is ways for the processor and TCON to divide the pixel should not be limited to the disclosed ways of front side, back side or odd, even numbers, but any ways that can divide the pixels into two, three or more parts are within the scope the present invention. The type of connection between the TCON and source drivers being either in series or point-to-point are merely for the purpose of explaining the present invention and are not intended to be limiting.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An apparatus for driving a display panel, comprising:
a processor outputting a first and second group of pixels onto a scan line;
a first and second timing controller operating in parallel, which rearrange a sequence of the first and second group of pixels, and output a first and second control signal, and the rearranged first and second group of pixels, respectively; and
a first and second group of source drivers respectively receiving the rearranged first and second group of pixels, and the first and second control signal, and accordingly generating driving voltages for the display panel.

2. The apparatus as claimed in claim 1, wherein each group of source drivers comprises a plurality of source drivers.

3. The apparatus as claimed in claim 1, wherein the pixels comprise impulsive pixels created by the processor from real pixels.

4. The apparatus as claimed in claim 1, further comprising a gate driver receiving a gate driving signal from one of the timing controllers.

5. The apparatus as claimed in claim 1, wherein at least one image frame is composed of the first and the second group of pixels.

6. The apparatus as claimed in claim 1, wherein the first and second group of source drivers receive the rearranged first and second group of pixels at the same time.

7. The apparatus of claim 1, wherein the pixels of the first group and the second group are respectively even and odd pixels on the scan line.

8. The apparatus of claim 1 wherein the pixels of the first group and the pixels of the second group are respectively a first and second half of pixels on the scan line.

9. A method for driving a display panel, comprising:
outputting a first and second group of pixels on a scan line from a processor;
operating a first and second timing controller in parallel to rearrange a sequence of the first and second group of pixels, and to output a first and second control signal, and the rearranged first and second group of pixels, respectively; and
receiving the rearranged first and second group of pixels, and the first and second control signal respectively by a first and second group of source drivers and accordingly generating driving voltages for the display panel.

10. The method as claimed in claim 9, before outputting the first and second group of pixels, further comprising:
creating impulsive pixels from real pixels;
composing the impulsive pixels and the real pixels to form pixels; and
dividing the pixels to the first and the second group of pixels.

11. The method of claim 9, wherein every group of source drivers has at least two source drivers.

12. The method of claim 9, wherein the first and second group of source drivers receive the rearranged first and second group of pixels at the same time.

13. The method of claim 9, wherein the pixels of the first group and the second group are respectively even and odd pixels on the scan line.

14. The method of claim 9, wherein the pixels of the first group and the pixels of the second group are respectively a first and second half of pixels on the scan line.

15. A liquid crystal display device, comprising:
a display panel; and
an apparatus for driving the display panel, comprising:
a processor outputting a first and second group of pixels onto a scan line;
a first and second timing controller operating in parallel, which rearrange a sequence of the first and second group of pixels, and output a first and second control signal, and the rearranged first and second group of pixels, respectively; and
a first and second group of source drivers respectively receiving the rearranged first and second group of pixels, and the first and second control signal, and accordingly generating driving voltages for the display panel.

16. The device of claim 15, wherein each group of source drivers comprises a plurality of source drivers.

17. The device of claim 15, wherein the pixels comprise impulsive pixels created by the processor from real pixels.

18. The device of claim 15, further comprising a gate driver receiving a gate driving signal form one of the timing controllers.

19. The device of claim 15, wherein at least one image frame is composed of the first and the second group of pixels.

20. The device of claim 15, wherein the first and second group of source drivers receive the rearranged first and second group of pixels at the same time.

21. The device of claim 15, wherein the pixels of the first group and the second group are respectively even and odd pixels on the scan line.

22. The device of claim 15, wherein the pixels of the first group and the pixels of the second group are respectively a first and second half of pixels on the scan line.
